(19) United States
(12) Patent Application Publication
(10) Pub. No.: US 2026/0095777 A1
(43) Pub. Date: Apr. 2, 2026

(54) TECHNIQUES FOR EXPANDING COVERAGE BY INTERMEDIATE WIRELESS DEVICES IN WIRELESS COMMUNICATIONS

(71) Applicant: QUALCOMM Incorporated, San Diego, CA (US)

(72) Inventors: Narayan PRASAD, Westfield, NJ (US); Meilong Jiang, Westfield, NJ (US); Ahmed Bedewy, Hillsborough, NJ (US); Tao Luo, San Diego, CA (US); Junyi Li, Greentown, PA (US)

(21) Appl. No.: 18/904,510

(22) Filed: Oct. 2, 2024

(51) Int. Cl. H04W 16/28; H04W 24/10

(52) U.S. Cl. CPC H04W 16/28; H04W 24/10

(57) ABSTRACT

Aspects described herein relate to configuring one or more reflective elements and a background element of an intermediate wireless device to reflect wireless signals. A first indication for configuring one or more reflective elements on the intermediate wireless device can be received from a network node. The one or more reflective elements can be configured based on the first indication. A second indication for configuring a state of a background element of the intermediate wireless device can be received from the network node. The state of the background element can be configured based on the second indication. Other aspects relate to transmitting the indications to configure the intermediate wireless device.

### FIELD OF THE DISCLOSURE

Aspects of the present disclosure relate generally to wireless communication systems, and more particularly, to intermediate wireless devices with reflective elements such as reconfigurable intelligent surfaces (RISs).

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes one or more reflective elements and a background element to reflect wireless signals, one or more memories configured to, individually or in combination, store instructions, and one or more processors communicatively coupled with the one or more memories. The one or more processors are, individually or in combination, configured to execute the instructions to cause the apparatus to receive, from a network node, a first indication for configuring the one or more reflective elements, configure the one or more reflective elements based on the first indication, receive, from the network node, a second indication for configuring a state of the background element, and configure the state of the background element based on the second indication.

In another aspect, a method for configuring one or more reflective elements and a background element of an intermediate wireless device to reflect wireless signals is provided that includes receiving, from a network node, a first indication for configuring one or more reflective elements on the intermediate wireless device, configuring the one or more reflective elements based on the first indication, receiving, from the network node, a second indication for configuring a state of a background element of the intermediate wireless device, and configuring the state of the background element based on the second indication.

In another aspect, one or more computer-readable media including code executable by one or more processors for configuring one or more reflective elements and a background element of an intermediate wireless device to reflect wireless signals are provided. The code includes code for receiving, from a network node, a first indication for configuring one or more reflective elements on the intermediate wireless device, configuring the one or more reflective elements based on the first indication, receiving, from the network node, a second indication for configuring a state of a background element of the intermediate wireless device, and configuring the state of the background element based on the second indication.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a base station, in accordance with various aspects of the present disclosure;

FIG. 4 is a block diagram illustrating an example of a intermediate wireless device, in accordance with various aspects of the present disclosure;

FIG. 5 illustrates examples of surfaces of intermediate wireless devices, in accordance with aspects described herein;

FIG. 6 illustrates examples of layers that can be used to construct an intermediate wireless device or a background element thereof, in accordance with aspects described herein;

FIG. 7 is a flow chart illustrating an example of a method for controlling one or more reflective elements and/or a background element of an intermediate wireless device, in accordance with aspects described herein;

FIG. 8 is a flow chart illustrating an example of a method for configuring an intermediate wireless device, in accordance with aspects described herein;

FIG. 9 illustrates one example of a configuration of a surface of an intermediate wireless device as a smooth mirror wall, in accordance with aspects described herein;

FIG. 10 illustrates one example of a configuration of a surface of an intermediate wireless device as a mirror wall as diffuse scatterer, in accordance with aspects described herein;

FIG. 11 illustrates one example of a configuration of a surface of an intermediate wireless device as a diffuse scatterer for non-line-of-sight (NLoS) communications, in accordance with aspects described herein;

FIG. 12 illustrates one example of a configuration of a surface of an intermediate wireless device as a metal background for NLoS communications, in accordance with aspects described herein;

FIGS. 13 and 14 illustrate examples of a multi-step configuration of a surface of an intermediate wireless device for opportunistic localization, in accordance with aspects described herein;

FIG. 15 illustrates examples of states of a surface of an intermediate wireless device having distributed sets of reflective elements, in accordance with aspects described herein;

FIG. 16 illustrates examples of states of a surface of an intermediate wireless device having extended sets of reflective elements, in accordance with aspects described herein;

FIG. 17 illustrates examples of a top view of a room and wall configuration where an intermediate wireless device with a switchable background element can be used to achieve different signal paths and/or wireless coverage for a transmitting node; and

FIG. 18 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to configurations of intermediate wireless devices to expand coverage thereof. In accordance with aspects described herein, intermediate wireless devices can be configured with reflective elements and a background element that can switch between states for various purposes, such as to provide reflection and/or scattering of received wireless signals. In sixth generation (6G) cellular systems, ensuring ubiquitous coverage and connectivity may be beneficial, but dense deployment of small cells or integrated access and backhaul (IAB) nodes may not be cost effective. As such, smart repeaters and reconfigurable intelligent surfaces (RISs) have emerged as alternatives for deployment. For example, a smart repeater (or network-controlled-repeater) can amplify signals received from some configured direction and forward the signals along another configured desired direction. A RIS is an array of reflecting elements that can be dynamically reconfigured to control the reflection and scattering of electromagnetic waves. RIS can inherently achieve full-duplex operation without injecting any dynamic noise. Generally, however, the operational footprint of a RIS may be restricted by the product path loss seen by a signal reflected via RIS, which may be exacerbated by the lack of amplification capability at an RIS.

Reconfigurable surfaces, such as RISs, can allow for configurable anomalous reflections (e.g., achieved by appropriately setting phases on constituent elements). Multiplicative fading (e.g., product-distance based path-loss), however, may restrict use to scenarios in which direct path is severely attenuated/blocked, and transmit (TX) and/or receive (RX) signal operations may be restricted as being relatively close to the surface. To expand operational footprint, the size (e.g., aperture area) of RIS array (and hence number of constituent tunable RIS elements) can be increased. The control for reconfigurability in this example, however, can become challenging, which may lead to cost/power scaling issues. Passive non-reconfigurable surfaces can also be used and scaled at low-cost and zero-power; however, such surfaces may only be able to achieve one specific configured reflection.

Aspects described herein relate to providing an intermediate wireless device, such as a RIS, having one or more reflective elements that can be dynamically reconfigured to control reflection and/or scattering of electromagnetic waves, and also a background element that can switch between states to provide for reflection and/or diffuse scattering of the electromagnetic waves received outside of the one or more reflective elements. In this regard, the RIS can provide a larger surface for reflecting or scattering signals without requiring individual tuneable reflective elements on the entire surface. For example, the background element of the intermediate wireless device can surround the one or more reflective elements. For example, the background element can provide a metal plate background as a perfect electrical conductor (PEC) in one state and/or a randomized background with a scattering pattern, or a dipole array layer, to provide diffuse scattering. In an example, the background element can include moveable layers configured at a gap, where the gap can be controlled by a motor or other piezoelectric material or device to achieve a certain state (e.g., the metal plate background state or the randomized background state). In an example, a network node in the wireless network can control the background element of the surface (and/or the one or more reflective elements) to achieve a desired functionality, as described in further detail herein.

In this regard, aspects described herein can reduce cost of constructing RISs with larger surface area by utilizing the background element for an area surrounding the reflective elements, instead of using only reflective elements over the entire surface. In addition, power used to control reflective elements can be reduced by using the background element, thus requiring a less number of reflective elements on the larger surface. In addition, as described, using larger surfaces for the RIS can expand the coverage and/or connectivity provided by the RIS, which can improve user experience when using devices (e.g., user equipment (UE)) that communicate with the network via the RISs.

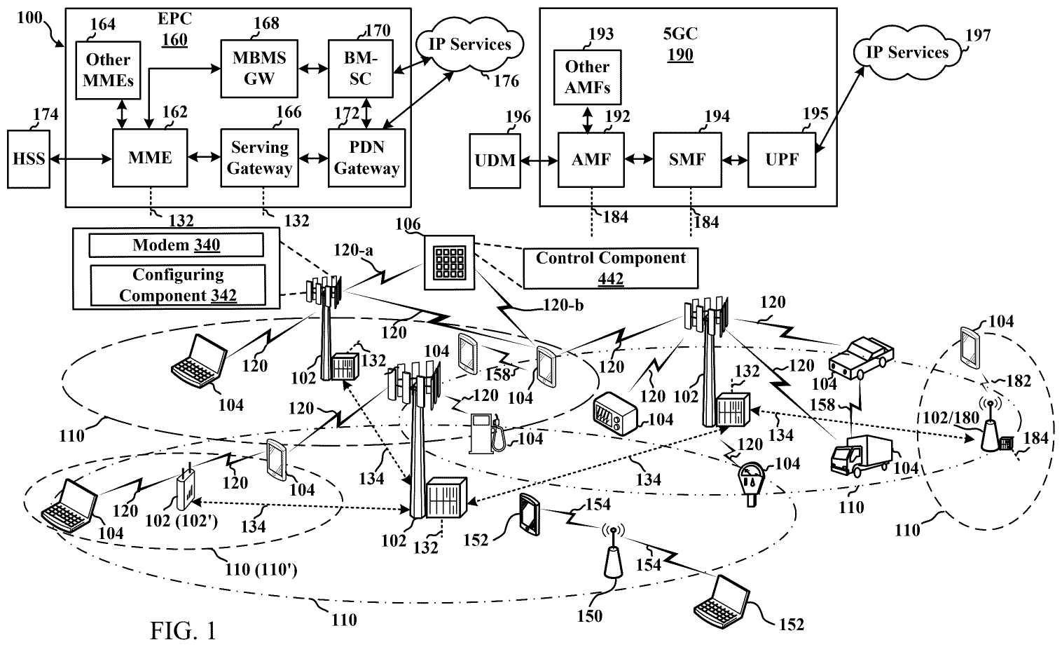

The described features will be presented in more detail below with reference to FIGS. 1-18.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In an example, the wireless communications system and access network 100 may also include an intermediate wireless device 106, such as a RIS, that can reflect signals received from a base station 102, gNB 180, a UE in sidelink communications, etc. to a UE 104, or can reflect signals received from a UE 104 to a base station 102, gNB 180, another UE in sidelink communications, etc. For example, the intermediate wireless device 106 can be or can include a nearly passive device with antenna elements that can be configured or controlled to reflect signals from network nodes. Such devices may include substantially any planar surface that can include unit-cells or elements, whose properties can be dynamically controlled to tune wireless signals that are incident on the elements through reflection, refraction, focusing, collimation, modulation, and/or absorption, such as a RIS. In accordance with specific examples described herein, the intermediate wireless device 106 may also include a background element that can be switched among multiple states to reflect or scatter signals. In one example, the intermediate wireless device 106 can include a control component 442 (e.g., a control unit) for controlling the one or more reflective elements and/or the background element of the intermediate wireless device, as described further herein. In addition, some nodes may have a modem 340 and configuring component 342 for configuring the intermediate wireless device, as described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (cNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), cFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, the intermediate wireless device 106 can include a control component 442, which can be, be part of, or otherwise include, a control unit, for configuring one or more reflective elements, background element, or other portion of the intermediate wireless device 106. For example, control component 442 can be co-located with the intermediate wireless device 106 or may be remotely-located or otherwise communicatively coupled with the intermediate wireless device 106 to facilitate controlling the one or more reflective elements, background element, or other portions thereof. For example, control component 442 can control the one or more reflective elements by setting phases thereof to appropriate achieve anomalous reflections of wireless signals and/or can control the background element to switch between two or more states, such as a reflective state, a diffuse scattering state, etc., as described herein. In an example, the intermediate wireless device 106 can be controlled to receive signals 120-a from the base station 102 or gNB 180, and reflect the signals 120-b to a UE, and/or vice versa, in a spatial direction configured for or by the one or more reflective elements and/or background element of the intermediate wireless device 106. For example, a configuring component 342 of a base station 102 or gNB 180 can configure the intermediate wireless device 106 to reflect the signals in certain directions, where configuring component 342 can send the configuration to the intermediate wireless device 106 using OTA signaling, such as control signaling (e.g., sequence-based control channel for intermediate wireless devices, physical downlink control channel (PDCCH) or PDCCH-like control channel for intermediate wireless devices, etc.). In this example, control component 442 can apply the received configuration for a specified time interval, revert to a default configuration after the time interval, resolve conflicts between configurations that overlap in time interval (e.g., based on a priority, a time at which the configuration is received, etc.), and/or the like.

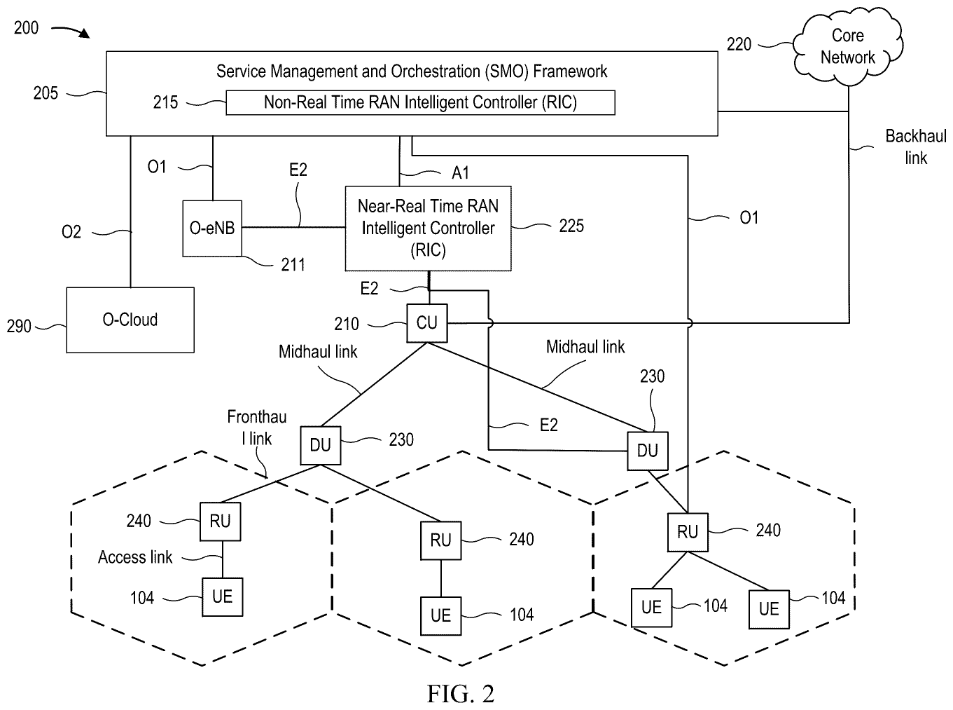

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an FI interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

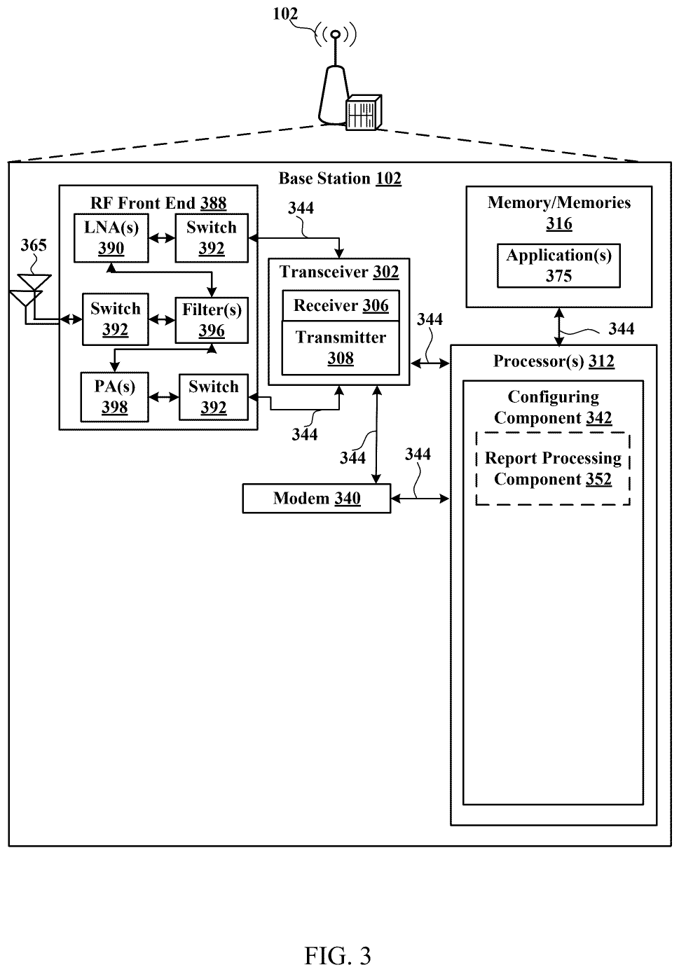

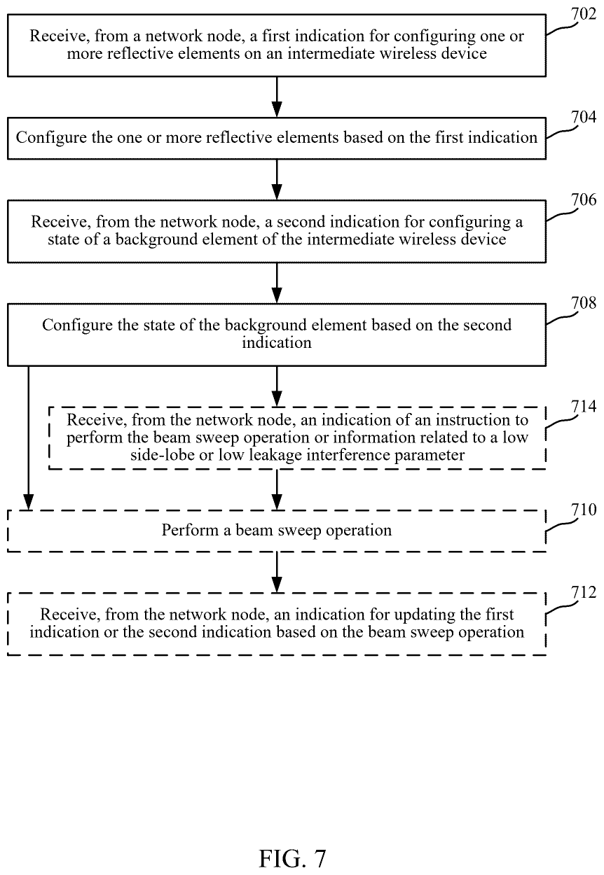

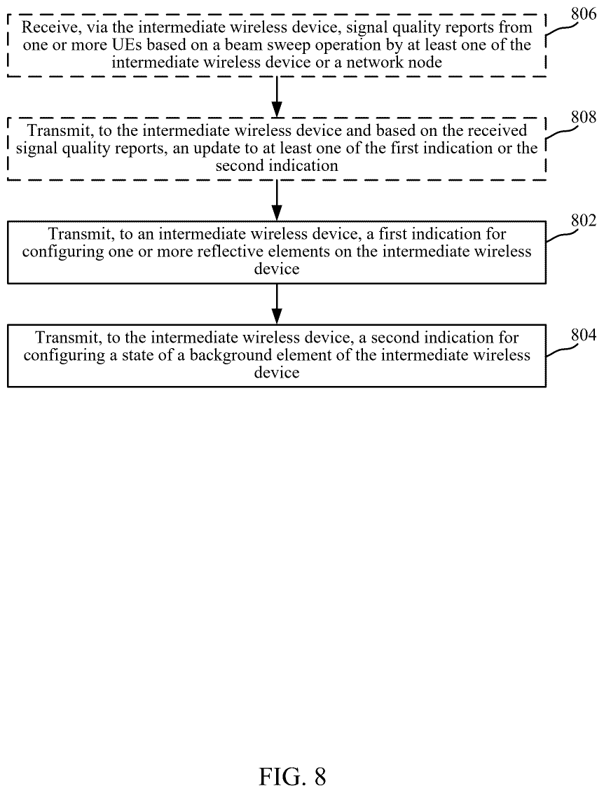

Turning now to FIGS. 3-18, aspects are depicted with reference to one or more components and one or more methods that may perform the actions or operations described herein, where aspects in dashed line may be optional. Although the operations described below in FIGS. 7 and 8 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of base station 102, which may include a monolithic base station, disaggregated base station, or other network node, may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or configuring component 342 for configuring an intermediate wireless device, in accordance with aspects described herein.

In an aspect, the one or more processors 312 can include a modem 340 and/or can be part of the modem 340 that uses one or more modem processors. Thus, the various functions related to configuring component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with configuring component 342 may be performed by transceiver 302.

Also, memory/memories 316 may be configured to store data used herein and/or local versions of applications 375 or configuring component 342 and/or one or more of its subcomponents being executed by at least one processor 312.

Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining configuring component 342 and/or one or more of its subcomponents, and/or data associated therewith, when base station 102 is operating at least one processor 312 to execute configuring component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, base station 102 may include RF front end 388, which may operate in communication with one or more antennas 365 and transceiver 302 for receiving and transmitting radio transmissions, for example, receiving wireless communications transmitted by at least one UE 104 (from the UE 104 or an intermediate wireless device 106), transmitting wireless communications to at least one UE 104, an intermediate wireless device 106, etc. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that base station 102 can communicate with, for example, one or more UEs 104. In an aspect, for example, modem 340 can configure transceiver 302 to operate at a specified frequency and power level based on the configuration of the base station 102 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of base station 102 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on configuration information associated with base station 102 as provided by the network.

In an aspect, configuring component 342 can optionally include a report processing component 352 for processing one or more measurement or signal quality reports received from one or more UEs, which may be used to control the intermediate wireless device 106, in accordance with aspects described herein.

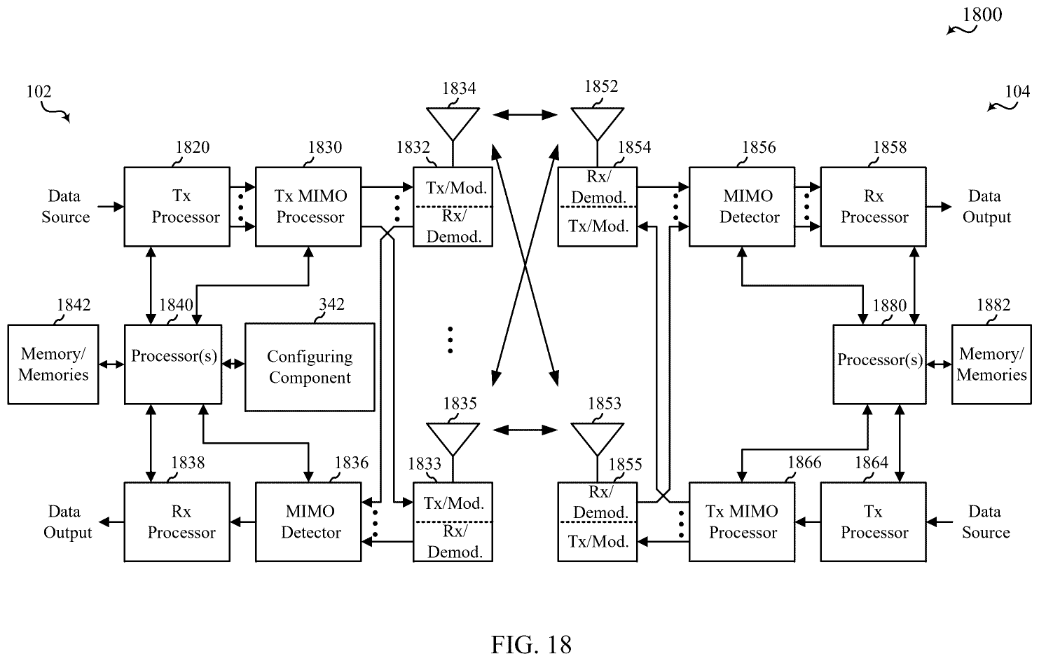

In an aspect, the processor(s) 312 may correspond to one or more of the processors described in connection with the base station in FIG. 18. Similarly, the memory/memories 316 may correspond to the one or more memories described in connection with the base station in FIG. 18.

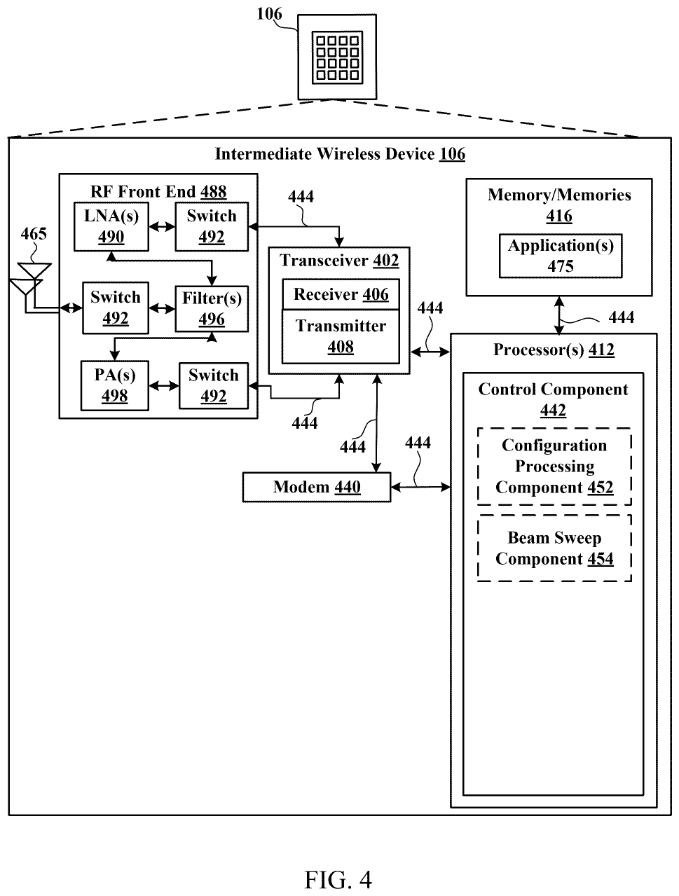

Referring to FIG. 4, one example of an implementation of an intermediate wireless device 106 (e.g., a RIS or other device with reflective elements, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or control component 442 for controlling one or more reflective elements and/or a background element of the intermediate wireless device 106, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of base station 102 104, as described above, but configured or otherwise programmed for intermediate wireless device operations as opposed to base station operations. In one example, many of the described components can be included in intermediate wireless device 106 for receiving control channel information for configuring the intermediate wireless device 106. The intermediate wireless device 106, however, may reflect signals from a base station or gNB using the antenna elements 465.

In an aspect, control component 442 can optionally include a configuration processing component 452 for receiving and/or processing a configuration for configuring one or more reflective elements or a background element of the intermediate wireless device 106, and/or a beam sweep component 454 for performing a beam sweep operation to transmit or reflect a signal in multiple spatial directions for measurement and/or reporting measurements by one or more UEs or other devices, in accordance with aspects described herein.

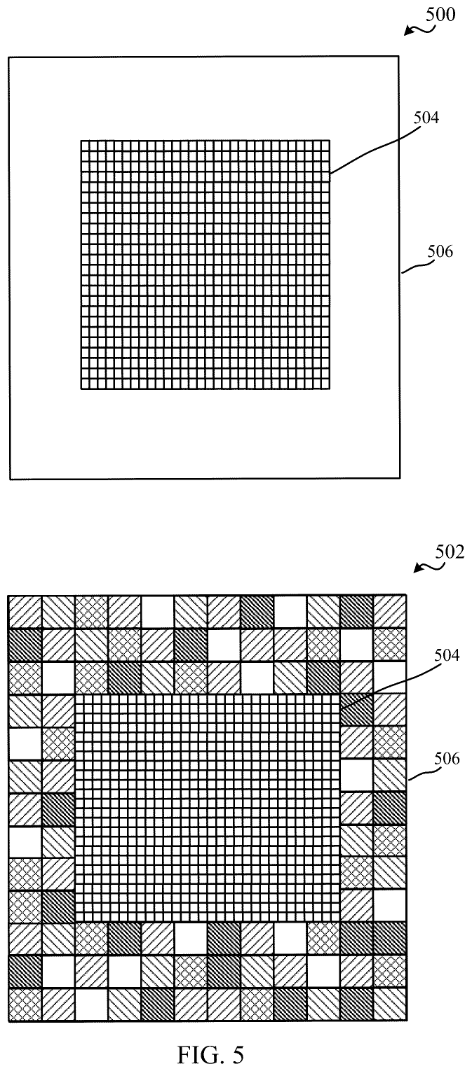

FIG. 5 illustrates examples of surfaces 500 and 502 of intermediate wireless devices, in accordance with aspects described herein. Surface 500 can include a set of reflective elements 504 and a background element 506. The set of reflective elements 504 can be similar to reflective elements used in a RIS. The background element 506 can be configured as a reflective background, which can be composed of a metal (e.g., PEC) to reflect signals that are received by, or otherwise incident on, the background element 506 potion of the surface 500. Surface 502 can include the set of reflective elements 504 and a background element 506, where the background element 506 can be configured as a randomized background, which can be composed of multiple reflective elements that are of varying or random angular position or electrical lengths within the background element 506 or otherwise induce several different directions of reflection for the signal to result in diffuse scattering of signals that are received by, or otherwise incident on, the background element 506 portion of the surface 502. For example, the multiple reflective elements of the background element 506 in FIG. 5 are illustrated using different hatch patterns, which can each represent a chosen phase shift. The illustrated background element 506 is one illustrative and non-limiting example, and a background element as described herein can have substantially any number of reflective elements having substantially any number of differing phase shifts. In one example, surfaces 500 and 502 can be provided as different states of a background element of the intermediate wireless device 106.

In one specific example, the intermediate wireless device 106 can include a background element that is mirror wall backed to provide either the metal surface shown of background element 506 in a first state (as shown for surface 500) or the randomized surface shown of background element 506 in a second state (as shown for surface 502). In this regard, for example, the background element of the intermediate wireless device 106 can include a mirror wall having a background surface that can switch to one of multiple states (e.g., with simplified and low-power/low-cost control), the multiple states including a metal (e.g., PEC) state and a randomized state. The mirror wall can be smooth and/or impenetrable, such that certain wireless signals cannot pass through the wall. This can provide security at a physical layer. The mirror wall, in some examples, can also house a RIS (or otherwise the set of reflective elements 504, which can typically be part of a RIS), which can have finer reconfigurability than the background element. For example, the set of reflective elements 504 (e.g., RIS constituent elements) can have n-bit per-element control, so that each such reflective element in the set can be set to one of 2ⁿ states. Optionally, one or more of the reflective elements can have amplification capability. Switching of the background surface may be at a coarser (e.g., slower) time scale than the reconfiguration rate of the set of reflective elements 502.

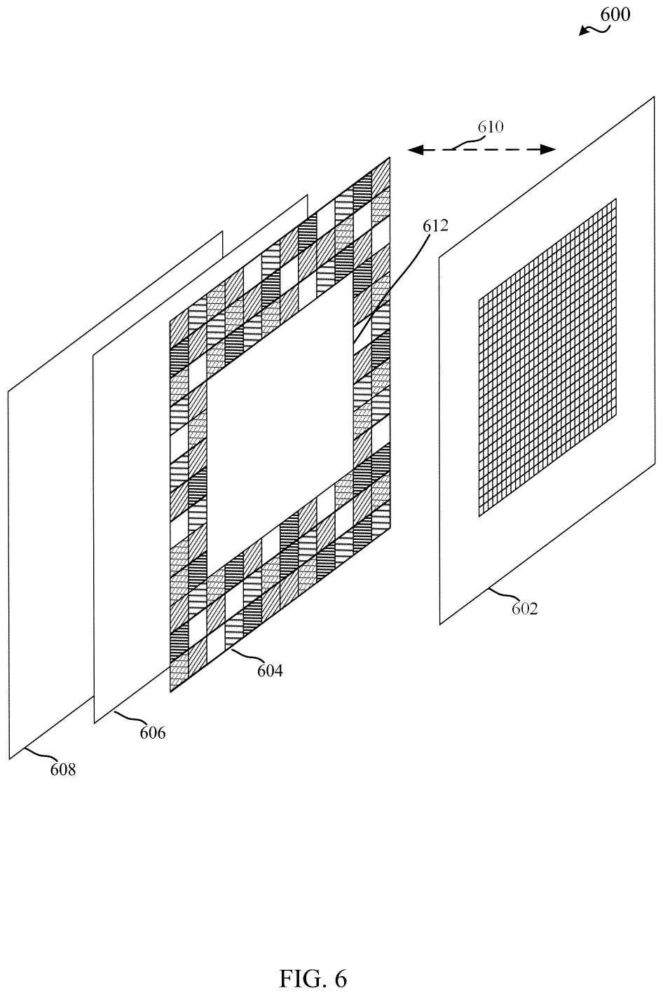

FIG. 6 illustrates examples of layers 600 that can be used to construct an intermediate wireless device 106 or a background element thereof, in accordance with aspects described herein. Layers 600 can include a moveable substrate layer 602 that can include the set of reflective elements, such as reflective elements 504 shown in FIG. 5, a scattering pattern layer 604, such as background element 506 shown in FIG. 5, a dielectric layer 606, and/or a metal ground 608. In one example, scattering pattern layer 604 can include a shadow region 612 resulting from alignment with the set of reflective elements in the moveable substrate layer 602. In some examples, the shadow region 612 can be used to house control circuitry related to the intermediate wireless device 106 (e.g., to house processor(s) 412, memory/memories 416, transceiver 402, etc., shown in FIG. 4).

In an example, the background element of the intermediate wireless device 106 can be constructed by overlaying the moveable substrate layer 602 over the scattering pattern layer 604 backed by the dielectric layer 606 and the ground 608. The background element can include a controllable gap 610 between the moveable substrate layer 602 and the scattering pattern layer 604 to enable changing its transmission or reflection coefficient by moving the moveable substrate layer 602 closer to, or further from, the scattering pattern layer 604. For example, the gap between movable substrate layer 602 and scattering pattern layer 604 can be adjustable, and/or may be controlled by a motor or piezoelectric material (not shown). In an example, when the gap is less than a threshold, the movable substrate layer 602 can act as a metal reflector substantially reflecting incident signal at a design operating frequency (e.g., 28 GHZ), such as shown of background element 506 in FIG. 5. In an example, when the gap is greater than or equal to a threshold, the movable substrate layer 602 can act as a transparent surface, which can substantially allows incident signals (from either side) to pass through at a design operating frequency (e.g., 28 GHz). In this case, for example, the signal can be reflected by the scattering pattern layer 604 and hence the overall surface composed of layers 600 can act as a diffuse scatterer.

In another example, the moveable substrate layer 602 can be provided as a dipole array, which can have dipoles loaded with fixed non-identical impedances, and upon which the set of reflective elements 504 can be placed, and the surface can include a ground layer 608, which may be a PEC ground plane, without layers 604 and 606. In this example, the dipole array can move with respect to the PEC ground plane, which can change the behavior of the layers 602 and 608 from scattering to reflecting.

For example, neglecting mutual coupling, the impact of each loaded dipole can be expressed as

$$\frac{{l}_{a} {\check{F}}^{{}_{r}}}{{Z}_{L} + {Z}_{a}} ,$$

where lₐ is the effective length of the dipole array, F̌^{r} is the radiation pattern of each dipole element, Z_{L} is the dipole load impedances, and Zₐ is the self impedance. Dipole load impedances {Z_{L}} can be chosen to realize uniform scattering of incident signals, assuming a certain separation distance. In addition, the self impedance Zₐ and radiation pattern of each dipole element F̌^{r} and effective length, lₐ, can depend on the separation from ground plane.

FIG. 7 illustrates a flow chart of an example of a method 700 for controlling one or more reflective elements and/or a background element of an intermediate wireless device, in accordance with aspects described herein. In an example, an intermediate wireless device 106, or corresponding control component 442, can perform the functions described in method 700 using one or more of the components described in FIGS. 1 and 4.

In method 700, at Block 702, a first indication for configuring one or more reflective elements on an intermediate wireless device can be received from a network node. In an aspect, configuration processing component 452, e.g., in conjunction with processor(s) 412, memory/memories 416, transceiver 402, control component 442, etc., can receive, from the network node (e.g., a base station 102 or gNB 180), the first indication for configuring one or more reflective elements on the intermediate wireless device 106. For example, configuration processing component 452 can receive the indication from the network node in control signaling, which may be transmitted using PDCCH or PDCCH-like signaling and/or corresponding communication channel. In this example, control component 442 may include or be communicatively coupled to RF circuitry, such as RF front end 488, transceiver 402, etc., that can operate as a UE or other node of the wireless network to receive signaling from the network node (e.g., base station 102 or gNB 180). For example, the network node can configure the intermediate wireless device 106 to receive control signaling over a control channel, such as PDCCH, for dynamically configuring the reflective elements thereof.

In method 700, at Block 704, the one or more reflective elements can be configured based on the first indication. In an aspect, configuration processing component 452, e.g., in conjunction with processor(s) 412, memory/memories 416, transceiver 402, control component 442, etc., can configure the one or more reflective elements (e.g., reflective elements 504 in FIG. 5) based on the first indication. For example, configuration processing component 452 can set phases on the one or more reflective elements based on the configuration to achieve configurable anomalous reflections of signals that are received by, or otherwise incident on, the set of reflective elements. In one example, the configuration from the base station 102 or gNB 180 can indicate a voltage or phase to be applied for each reflective element, and configuration processing component 452 can set the voltage or phase as indicated in the configuration. In an example, this configuration can occur dynamically and may be modified for certain signals transmitted by the base station 102 or gNB 180 or transmitted by a UE for receiving at the base station 102 or gNB 180, etc.

In method 700, at Block 706, a second indication for configuring a state of a background element of the intermediate wireless device can be received from the network node. In an aspect, configuration processing component 452, e.g., in conjunction with processor(s) 412, memory/memories 416, transceiver 402, control component 442, etc., can receive, from the network node (e.g., a base station 102 or gNB 180), the second indication for configuring the background element of the intermediate wireless device 106. For example, configuration processing component 452 can receive the indication from the network node in control signaling, which may be transmitted using PDCCH or PDCCH-like signaling and/or corresponding communication channel.

In method 700, at Block 708, a state of the background element can be configured based on the second indication. In an aspect, configuration processing component 452, e.g., in conjunction with processor(s) 412, memory/memories 416, transceiver 402, control component 442, etc., can configure the state of the background element (e.g., one or more states of background element 506) based on the second indication. In one example, configuration processing component 452 can, based on the second indication, move one or more layers 600, such as a moveable substrate layer 602 in FIG. 6, of a surface to achieve the state of the background element, as specified by the second indication. As described, for example, the second indication can indicate a first state or a second state (e.g., a reflective state or a diffuse scatter state) or another state, and control component 442 can control the layers 600 to achieve the state, such as by moving the moveable substrate layer 602 or otherwise activating or deactivating one or more of the layers 600. In an example, this configuration can occur at a slower rate than configuring reflective elements, and may be modified for certain environments or detected environmental parameters, such as detected side-lobe or interference levels, or during certain procedures, such as beam sweeping operations, etc.

In some examples, the intermediate wireless device 106 can be used to perform a beam sweep operation to allow a transmitting node to transmit signals using multiple transmit beams (in multiple spatial directions) reflecting from the surface of the intermediate wireless device 106 and/or to allow a receiving node to receive the reflected signals using multiple receive beams (in multiple spatial directions). In one example, the beam sweep operation may include the transmitting node, or another network node, controlling the intermediate wireless device 106 to reflect signals in a certain manner or direction (e.g., by sending indications to configure the set of reflective elements and/or the background element).

Thus, in an example, in method 700, optionally at Block 710, a beam sweep operation can be performed. In an aspect, beam sweep component 454, e.g., in conjunction with processor(s) 412, memory/memories 416, transceiver 402, control component 442, etc., can perform the beam sweep operation. For example, the transmitting node can transmit multiple beams for reflecting by the intermediate wireless device 106 in different directions. This can include the transmitting node transmitting the multiple beams in different directions and/or the transmitting node (or another node) controlling the intermediate wireless device 106 to reflect the transmit beams in different directions. In one example, the intermediate wireless device 106 reflects one or more signals received from the transmitting node as part of the beam sweep operation and/or controls the set of reflective elements and/or background element for each beam to modify reflection of the beam as part of the beam sweep operation. For example, the transmitting node can transmit one or more transmit beams which beamform a reference signal. In one example, the transmitting node can transmit a single transmit beam, which beamforms a reference signal, and the intermediate wireless device 106 can configure its reflective elements to reflect the single transmit beam in multiple directions to sweep the transmit beam. In another example, the transmitting node can transmit multiple transmit beams (e.g., separated in time), and the intermediate wireless device 106 can configure its reflective elements (e.g., in time) to reflect each transmit beam at a different direction to sweep the transmit beams.

In addition, as part of the beam sweep operation, the receiving node can receive the reflected transmit beams, which may include the receiving node also using different receive beams to receive one or more of the reflected transmit beams, and can measure a signal quality or signal power of the reflected transmit beams as received. The receiving node can report measured signal quality or signal power of at least a subset of the reflected transmit beams as received to the transmitting node, which can allow the transmitting node to select a transmit beam and/or a control for the set of reflective elements to use in transmitting communications to the receiving node. For example, the receiving node can transmit the measured signal quality or signal power of a reflected transmit beam using the beam identical or similar to the receive beam it used to receive that reflected transmit beam. The intermediate wireless device can be configured, or maintained, at a configuration (including reflective elements and background element) identical or similar to the one it had during corresponding transmission by the transmitting node using the transmit beam. The transmitting node can then receive the signal quality report via the intermediate device.

In method 700, optionally at Block 712, an indication for updating the first indication or the second indication can be received from the network node based on the beam sweep operation. In an aspect, configuration processing component 452, e.g., in conjunction with processor(s) 412, memory/memories 416, transceiver 402, control component 442, etc., can receive the indication for updating the first indication or the second indication based on the beam sweep operation. In an example, the received indication can be a new first indication indicating to configure the one or more reflective elements to reflect signals in certain directions to achieve a spatial direction for communications transmitted from the transmitting node that are reported as desirable or optimal for receiving the communications at the receiving node. In another example, the received indication can additionally or alternatively be a new second indication indicating to configure the background element of the intermediate wireless device 106 to the reflective state (e.g., to improve signal strength in a direction) or the scattering state (e.g., to increase the number of directions for reflecting signals and ensuring no one direction has significantly higher strength of the reflection from the background element). In an example, control component 442 can accordingly configure the one or more reflective elements (e.g., configure phases of one or more individual elements) and/or the background element (e.g., configure a state of the background element) based on the received indication(s).

In method 700, optionally at Block 714, an indication of an instruction to perform the beam sweep operations or information related to a low side-lobe or low leakage interference parameter can be received from the network node. In an aspect, configuration processing component 452, e.g., in conjunction with processor(s) 412, memory/memories 416, transceiver 402, control component 442, etc., can receive, from the network node, the indication of the instruction to perform the beam sweep operation or information related to a low side-lobe or low leakage interference parameter. For example, the information related to a low side-lobe parameter or the low leakage interference parameter can correspond to a request or requirement of the network node to ensure only low side-lobes (e.g., side-lobes in reflected beam pattern having an energy or gain below a threshold) or low leakage interference (e.g., interference leaking from reflections to one or more unintended and protected directions having energy below a threshold). In this example, when the network node receives some information from one or more other network nodes about side-lobes or leakage interference being greater than the threshold, control component 442 can be instructed to set the state of the background element to be scattering. In addition, as an option, the beam sweep component 454 can be instructed to perform beam sweeping (e.g., at the instruction of the network node or transmitting node or otherwise), as described above. In another example, control component 442 can be instructed to set the background element to be scattering for each beam sweep operation (e.g., based on the instruction to perform the beam sweep operation) and/or can switch back to reflective state after the beam sweep operation. For example, configuration processing component 452 can receive the instruction in a PDCCH or PDDCH-like transmission, as described above, and beam sweep component 454 can perform the beam sweep based on the instruction.

FIG. 8 illustrates a flow chart of an example of a method 800 for configuring an intermediate wireless device, in accordance with aspects described herein. In an example, a network node, such as a base station 102 or gNB 180 (or a component of a disaggregated base station 102 or gNB 180), can perform the functions described in method 800 using one or more of the components described in FIGS. 1 and 3.

In method 800, at Block 802, a first indication for configuring one or more reflective elements on an intermediate wireless device can be transmitted to an intermediate wireless device. In an aspect, configuring component 342, e.g., in conjunction with processor(s) 312, memory/memories 316, transceiver 302, etc., can transmit, to the intermediate wireless device (e.g., intermediate wireless device 106), the first indication for configuring one or more reflective elements on the intermediate wireless device. For example, configuring component 342 can transmit the indication in control signaling, which may be transmitted using PDCCH or PDCCH-like signaling and/or corresponding communication channel. In an example, the network node can configure the intermediate wireless device 106 to receive control signaling over a control channel, such as PDCCH, for dynamically configuring the reflective elements thereof.

In method 800, at Block 804, a second indication for configuring a state of a background element of the intermediate wireless device can be transmitted to the intermediate wireless device. In an aspect, configuring component 342, e.g., in conjunction with processor(s) 312, memory/memories 316, transceiver 302, etc., can transmit, to the intermediate wireless device (e.g., intermediate wireless device 106), the second indication for configuring the background element of the intermediate wireless device. For example, configuring component 342 can transmit the indication in control signaling, which may be transmitted using PDCCH or PDCCH-like signaling and/or corresponding communication channel.

As described above, the intermediate wireless device 106 can receive the indications and accordingly configure reflective elements and/or a state of a background element to operate as specified in the indications. In an example, configuring component 342 can determine the first and/or second indications to control the intermediate wireless device 106 based on information received from one or more UEs to which signals are transmitted by the network node as reflected by the intermediate wireless device 106. In an example, configuring component 342 can generate the first indication or second indication, or updates to the first and/or second indications, for transmitting to the intermediate wireless device 106 based on the information received from the UEs.

In method 800, optionally at Block 806, signal quality reports can be received, via the intermediate wireless device, from one or more UEs based on a beam sweep operation by at least one of the intermediate wireless device or the network node. In an aspect, report processing component 352, e.g., in conjunction with processor(s) 312, memory/memories 316, transceiver 302, configuring component 342, etc., can receive, via the intermediate wireless device, signal quality reports (also referred to as measurement reports or signal measurements) from the one or more UEs (or more generally from a receiving node) based on a beam sweep operation by at least one of the intermediate wireless device or the network node (or more generally a transmitting node). For example, the one or more UEs can receive the reflected transmit beams from the transmitting node, as described above, and can measure a signal quality or signal power of the transmit beams (e.g., a reference signal received quality (RSRQ), RSRP, RSSI, SNR, etc.). The one or more UEs can generate a measurement report indicating the signal quality or signal power of the received transmit beams and can transmit the measurement report to the transmitting node via the intermediate wireless device.

For example, as described, the intermediate wireless device 106 can perform, or can allow the network node to perform, a beam sweep operation to transmit or reflect transmit beams from the transmitting node in different spatial directions as reflected by the intermediate wireless device 106. This can be achieved by the transmitting node transmitting the beams in different spatial directions at the intermediate wireless device 106, modifying one or more reflective elements of the intermediate wireless device 106, and/or the like. In this example, during the beam sweep operation, a receiving node can receive the transmit beams, measure a signal quality or strength thereof, and report the signal quality or strength to the transmitting node to allow the transmitting node to determine a transmit beam and/or intermediate wireless device 106 configuration resulting in a highest signal strength at the receiving node. This can allow the network node to receive the reports from the receiving node, via report processing component 352, and determine a transmit beam and/or control intermediate wireless device 106 for the receiving node to receive communications from the transmitting node.

In method 800, optionally at Block 808, an update to at least one of the first indication or the second indication can be transmitted to the intermediate wireless device based on the received signal quality reports. In an aspect, configuring component 342, e.g., in conjunction with processor(s) 312, memory/memories 316, transceiver 302, etc., can transmit, to the intermediate wireless device and based on the received signal quality reports, an update to at least one of the first indication or the second indication. In this regard, for example, configuring component 342 can control the intermediate wireless device 106 by controlling the one or more reflective elements or a state of the background element based on the received signal quality reports. For example, configuring component 342 can instruct the intermediate wireless device 106 to tune one or more reflective elements, using the first indication, to achieve a signal spatial direction for which the one or more UEs reported a desirable or optimal signal quality or power measurement. In another example, configuring component 342 can instruct the intermediate wireless device 106 to set a state of the background element, using the second indication, to achieve a higher signal strength (e.g., via reflective state, such as when the one or more UEs report a single direction with a sufficient or highest signal quality or power measurement and the direction is aligned or close to the specular direction of reflection from the background element), or to achieve a diffuse scattering or larger number of reflected spatial directions (e.g., via scattering state, such as when the one or more UEs report low signal quality or power measurement in all directions or when the one or more UEs report a single direction with a sufficient or highest signal quality that is separated or different beyond a threshold from the specular direction of reflection from the background element). Various examples for controlling the reflective elements or background element state of an intermediate wireless device 106 or corresponding surface are described below.

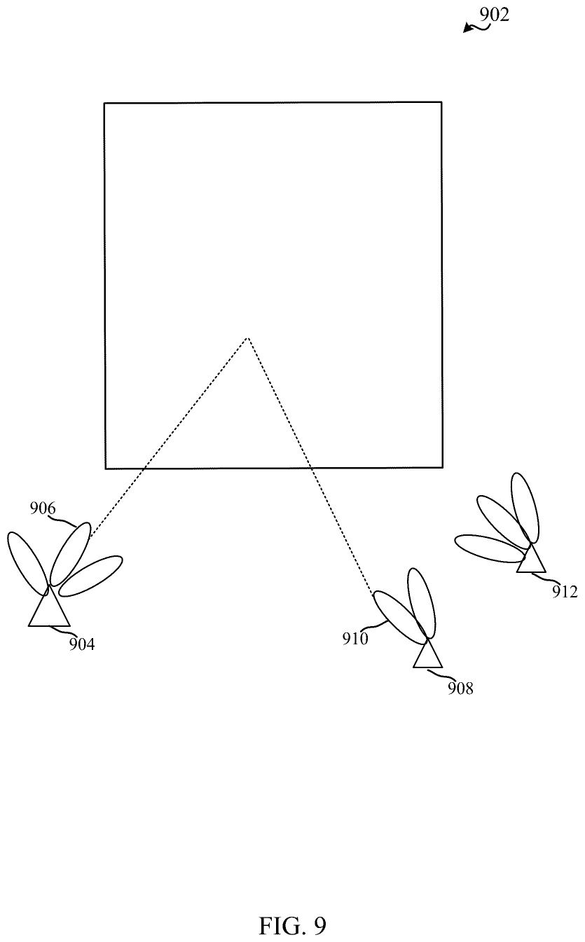

FIG. 9 illustrates one example of a configuration of a surface 902 of an intermediate wireless device as a smooth mirror wall, in accordance with aspects described herein. In this example, the first indication can relate to configuring a set of reflective elements of the intermediate wireless device 106 to be in a same state (e.g., each element having a same phase), and the second indication can relate to configuring the background element to be in a metal state or reflective state. For example, metal state can refer to a state where a moveable layer of the background element is sufficiently close to the metal ground layer, such that signals incident on the background element penetrate to, and reflect from, the metal ground layer. As such, surface 902, which can include the set of reflective elements and the background element, can be a smooth mirror wall. With the surface 902 of the intermediate wireless device 106 configured in this state, a transmitting node 904 that transmits signals via transmit beam 906 can be reflected by the surface 902, and a receiving node 908 can receive the signals via receive beam 910. In this example, transmitting node 904 and receiving node 908 can perform beam alignment to establish a specular reflect link via the surface 902 of the intermediate wireless device 106 configured as the smooth mirror. In this example, link budget between the transmitting node 904 and receiving node 908 can account for (i) locations of the transmitting and receiving nodes, and (ii) their set of available beams and/or beam widths. The smooth mirror can allow for reflecting signals that can be received via specular reflection with higher signal strength than where the surface is configured for diffuse scattering. In this example, another receiving node 912 may not receive the reflected signals as it cannot be reached via specular reflection based on location and/or available set of beams.

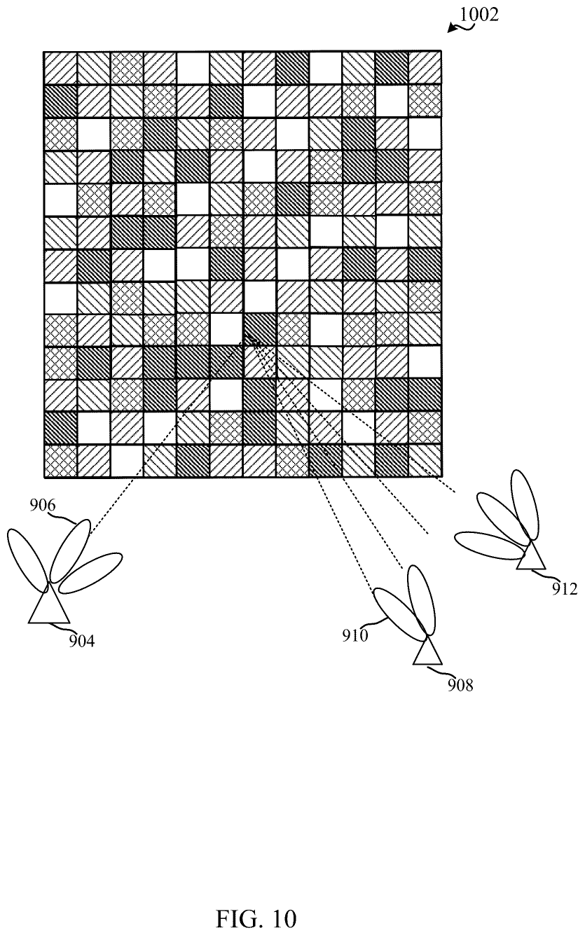

FIG. 10 illustrates one example of a configuration of a surface 1002 of an intermediate wireless device as a mirror wall as diffuse scatterer, in accordance with aspects described herein. In this example, the first indication can relate to configuring a set of reflective elements of the intermediate wireless device 106 to be in a randomized state (e.g., each element having a different randomized phases), and the second indication can relate to configuring the background element to be in a diffuse scattering state. In this example, the mirror wall provided by the surface 1002 of the intermediate wireless device 106 can be a diffuse scatterer. With the intermediate wireless device 106 configured in this state, a transmitting node 904 that transmits signals via transmit beam 906 can be reflected by the surface 1002. A first receiving node 908 can receive the reflected signals via receive beam 910 and/or other receive beams, and a second receiving node 912 can receive the reflected signals via one or more receive beams as well, due to the scattering property of the reflected signals, though the reflected signals may have lower received signal strength as compared to signals reflected via the smooth mirror wall configuration. In this example, intermediate wireless device 106 can perform coarse beam alignment to establish a non-specular reflect link via the surface 1002 configured as the diffuse scatterer. In this example, diffuse scattering via the mirror wall can be enough to setup links at shorter range than smooth mirror wall without elaborate beam alignment procedures. This can be useful for common channels (e.g., synchronization signal block (SSB), random access channel (RACH), other broadcast signaling, etc.) where information for accurate beam alignment may not be available and coverage thresholds may be lower than those used in smooth mirror wall scenarios.

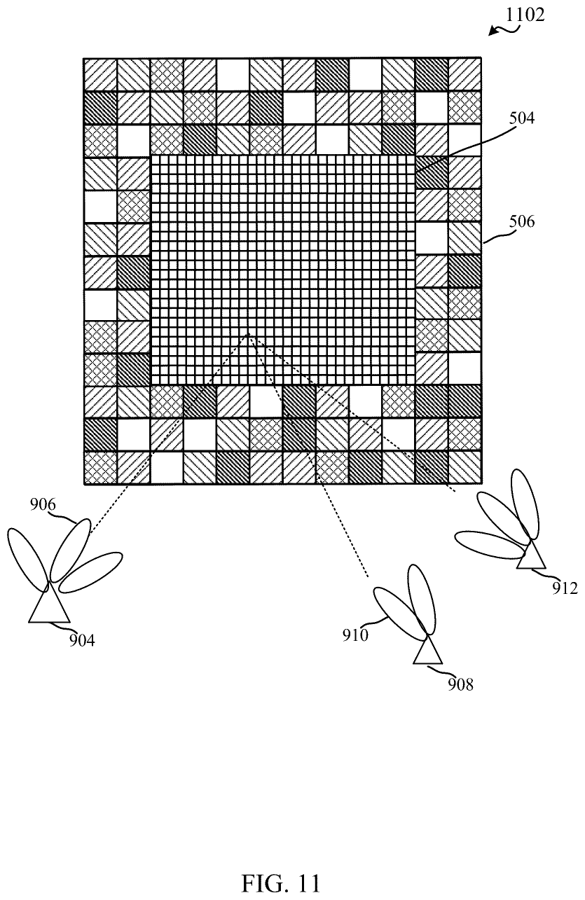

FIG. 11 illustrates one example of a configuration of a surface 1102 of an intermediate wireless device as a diffuse scatterer for non-line-of-sight (NLoS) communications, in accordance with aspects described herein. In this example, the second indication can relate to configuring the background element 506 to be in a diffuse scattering state. With the background element 506 of the surface 1102 configured in this state, a transmitting node 904 that transmits signals via transmit beam 906 can be reflected by the set of reflective elements 504 with the diffuse scatterer background element 506, which can result in no dominant side-lobes, but decreased signal strength. A first receiving node 908 can receive the reflected signals via receive beam 910, and a second receiving node 912 can receive the reflected signals via one or more receive beams as well, due to the scattering property of the reflected signals, but at a relatively decreased signal strength as compared to a metal or reflective state background element. In this example, the intermediate wireless device can perform pattern selection (e.g., pattern sweep and/or beam sweep operation, which may be based on beam sweep component 454 performing the beam sweep operation), by configuring the background element 506 as a diffuse scatterer and the set of reflective elements 504 for beam sweeping, to achieve anomalous reflection.

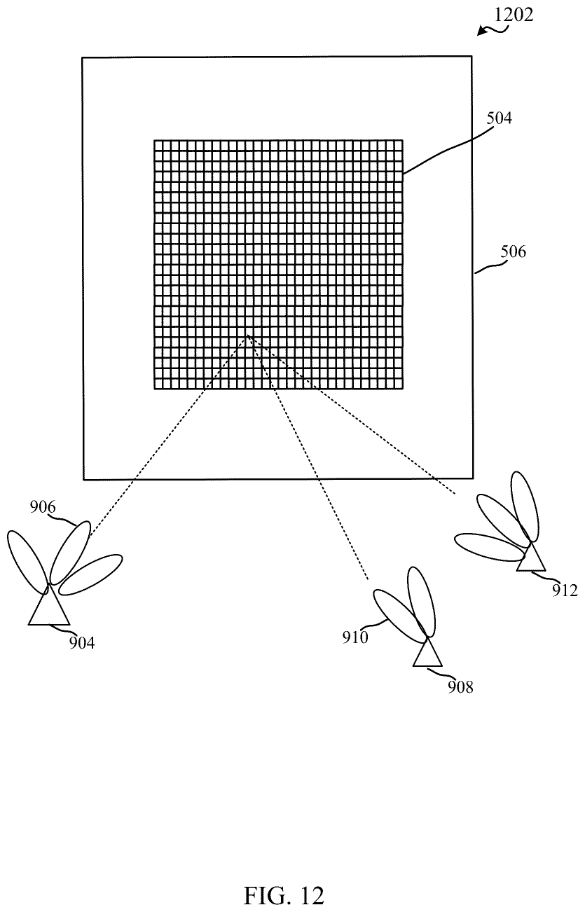

FIG. 12 illustrates one example of a configuration of a surface 1202 of an intermediate wireless device as a metal background for non-line-of-sight (NLoS) communications, in accordance with aspects described herein. In this example, the second indication can relate to configuring the background element 506 to be in a metal background or reflective state. With the background element 506 of the surface 1202 configured in this state, a transmitting node 904 that transmits signals via transmit beam 906 can be reflected by the set of reflective elements 504 with the metal background element 506, where the reflected signals can have relatively higher signal strength than those reflected using a diffuse scatterer state background element, but may have dominant side-lobes in the specular direction. A first receiving node 908 can receive the reflected signals via receive beam 910, and a second receiving node 912 can receive the reflected signals via one or more receive beams as well, which may be based on controlling the set of reflective elements 504 to reflect the signals in the direction of receiving nodes 908 and 912. In this example, the intermediate wireless device can perform pattern selection (e.g., pattern sweep and/or beam sweep operation, which may be based on beam sweep component 454 performing the beam sweep operation), by configuring the background element 506 as a reflective surface and the set of reflective elements 504 for beam sweeping, to achieve anomalous reflection.

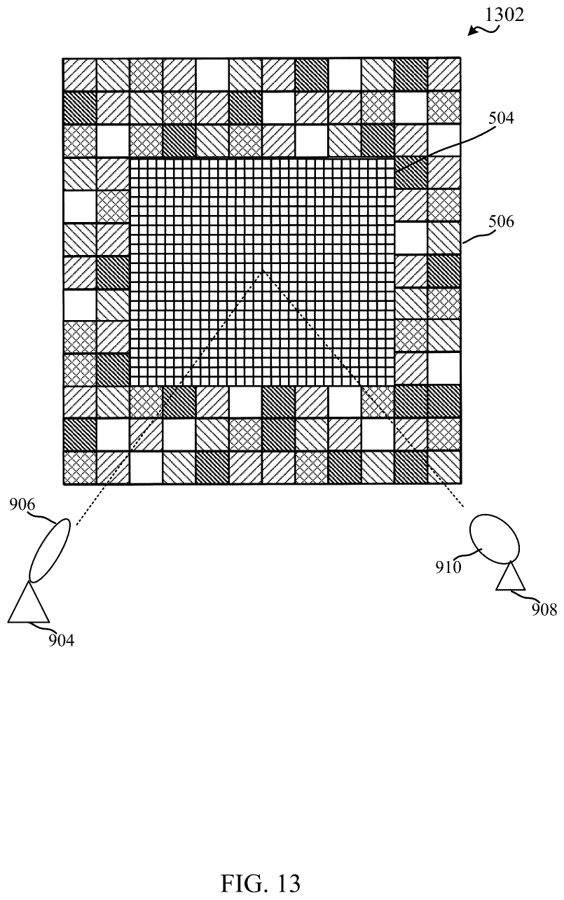

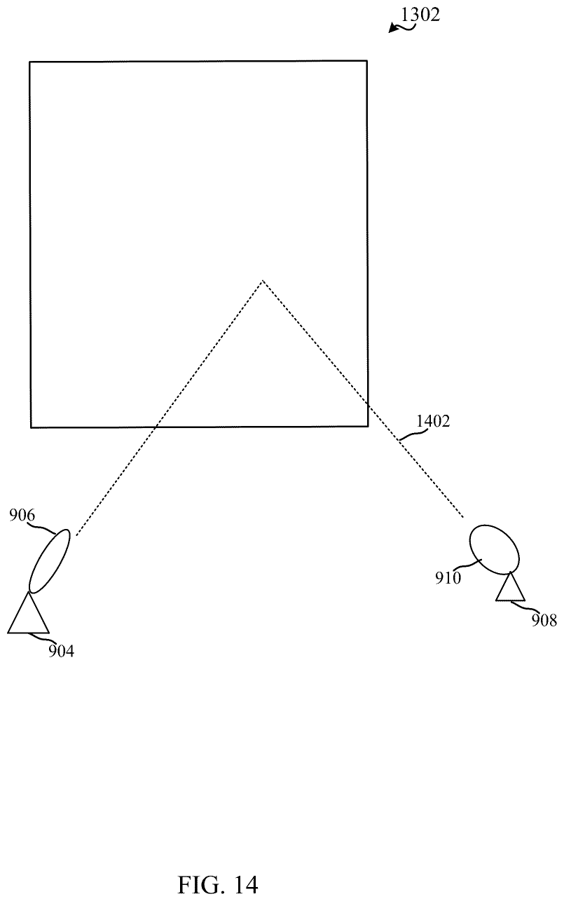

FIGS. 13 and 14 illustrate examples of a multi-step configuration of a surface 1302 of an intermediate wireless device for opportunistic localization, in accordance with aspects described herein. In this example, in a first step, the second indication can relate to configuring the background element 506 to be in a diffuse scattering state. With the background element 506 of the surface 1302 configured in this state, a transmitting node 904 that transmits signals via transmit beam 906 can transmit towards the center of the surface 1302 (and/or the center of the set of reflective elements 504), such that the signals are reflected by the set of reflective elements 504 with the diffuse scatterer background element 506, which can result in no dominant side-lobes, but decreased signal strength. A first receiving node 908 can receive the reflected signals via receive beam 910. In an example, the intermediate wireless device 106 can conduct a pattern sweep (e.g., a beam sweep operation, which may be based on beam sweep component 454 performing the beam sweep operation) by configuring the background element 506 as a diffuse scatterer and the set of reflective elements 504 for beam sweeping. The intermediate wireless device 106 and/or the transmitting node 904 can detect a pattern of beams and/or surface configurations that result in highest received signal strength at the receiving node 908 (which is using a pseudo-omni receive beam), which can be based on signal quality or measurement reports received from the receiving node 908.

In a second step, configuring component 342 of the transmitting node 904 can transmit, and/or configuration processing component 452 of the intermediate wireless device 106 associated with the surface 1302 can receive, subsequent indications to configure a set of reflective elements of the intermediate wireless device 106 to be in a same state (e.g., each element having a same phase) and/or to configure the background element to be in a metal state (e.g., as described with respect to surface 902 in FIG. 9), such that surface 1302 is configured as a smooth mirror wall allowing specular reflections. In this example, beam sweep component 454 can perform a transmit beam sweep, whether initiated by the intermediate wireless device 106 or by the transmitting node 904 transmitting different beams for reflection by the surface 1302, to identify a transmit beam resulting in highest received signal strength at the receiving node 908 (which is using a pseudo-omni receive beam). Based on signal quality or measurement reports (which can, for instance, be received by the transmitting node 904 via the reflection by the intermediate device of the transmission by the receiving node 908 in the uplink), a visibility subset of likely beam directions for the receiving node 908 can be identified in a direction similar to that of signal 1402 based on feedback from receiving node 908. In one example, the second step may be performed before the first step described above.

In a third step, configuring component 342 of the transmitting node 904, and/or beam sweep component 454 of the intermediate wireless device 106, can use the visibility subset determined in the second step and the anomalous reflect beam direction determined in the first step, to determine a position or location of the receiving node 908. For example, based on signal strength of the visible beams reported by the receiving node 908 and the known anomalous reflect beam directions, configuring component 342 can triangulate a position or location of the receiving node 908. Localization can be opportunistic as it may not be possible when the receiving node 908 is outside the specular visibility zone of the transmitting node 904 when using the surface 1302 configured as a smooth mirror wall to reflect signals.

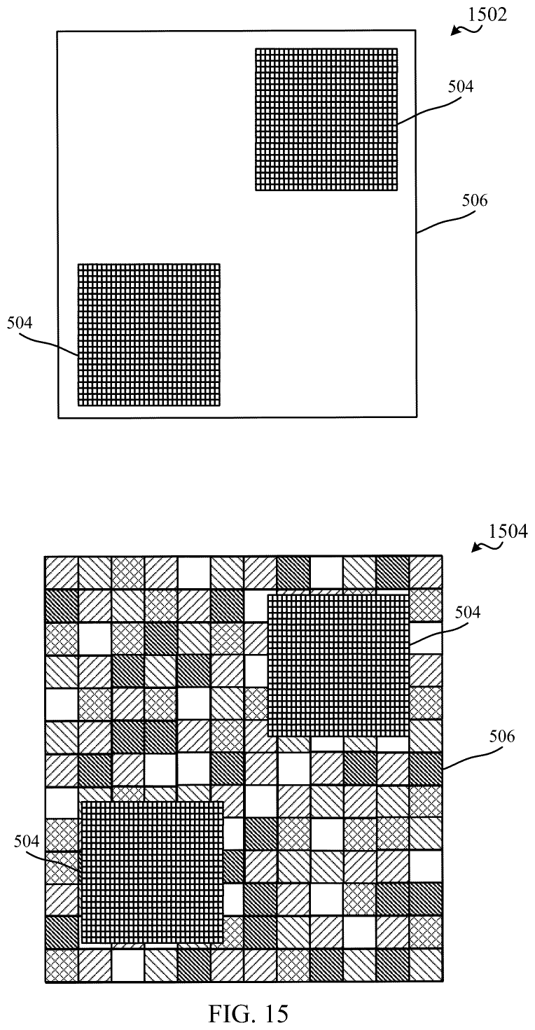

FIG. 15 illustrates examples of states 1502 and 1504 of a surface of an intermediate wireless device 106 having distributed sets of reflective elements 504, in accordance with aspects described herein. As described above, in state 1502, a background element 506 can be in a reflective or metal state, and in state 1504, the background element 506 can be in a diffuse scatter or randomized state. In this example, each set of reflective elements 504 can be attached to or placed on the surface considering one or more properties thereof, such as array dimension of the elements, mutual separation, operating frequency, distance from the transmitting node, etc. This can avoid keyhole channel effect and can enable higher rank transmission from the transmitting node to one or more receiving nodes via reflections from the mirror wall.

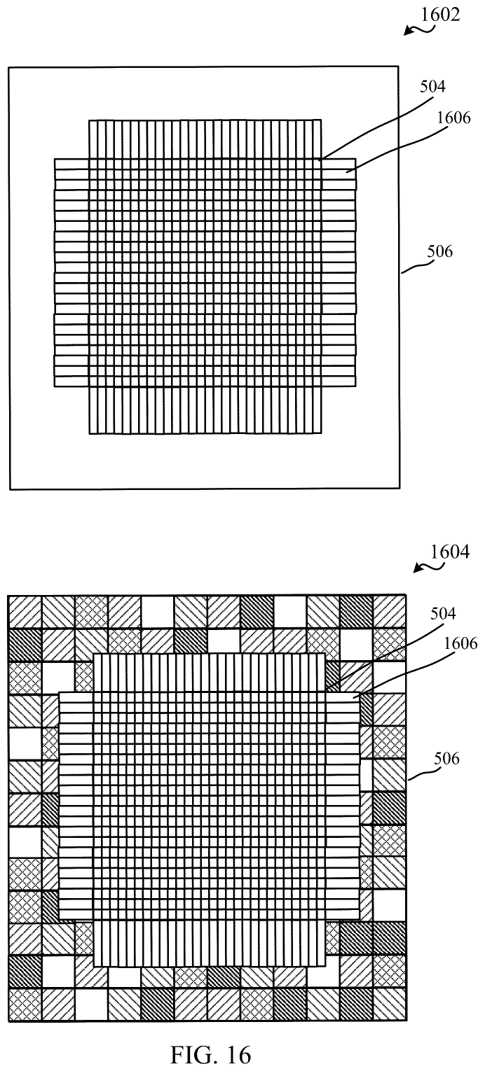

FIG. 16 illustrates examples of states 1602 and 1604 of a surface of an intermediate wireless device 106 having extended sets of reflective elements 504, in accordance with aspects described herein. As described above, in state 1602, a background element 506 can be in a reflective or metal state, and in state 1604, the background element 506 can be in a diffuse scatter or randomized state. In this example, each set of reflective elements 504 can have extensions 1606 for finer reconfigurability such that reflective elements on the extensions 1606 can have control that is paired to the nearest reflective element (e.g., communicatively coupled by a control line providing an electrical path between the respective tunable components of the reflective elements), thus providing additional control while maintaining low control line and circuit complexity.

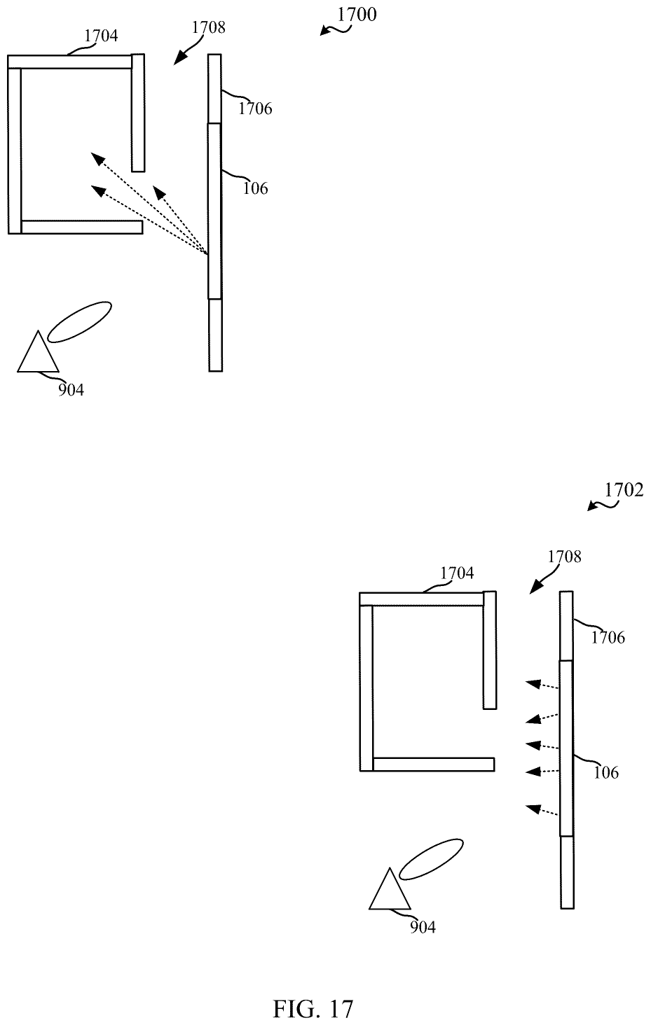

FIG. 17 illustrates examples 1700 and 1702 of a top view of a room and wall configuration where an intermediate wireless device 106 with a switchable background element can be used to achieve different signal paths and/or wireless coverage for a transmitting node 904, in accordance with aspects described herein. In examples 1700 and 1702, a room 1704 with an opening is depicted along with a wall 1706 along side the room 1704, creating a hallway or corridor 1708. The wall 1706 can include an intermediate wireless device 106 that reflects signals from a transmitting node 904. When the intermediate wireless device 106 switches the background element to be in a reflective or metal (e.g., PEC) state, as shown in example 1700, the intermediate wireless device 106 can provide specular reflection of signals from the transmitting node 904 in a specific direction and with higher power into room 1704 to provide coverage within the room 1704. When the intermediate wireless device 106 switches the background element to be in a randomized or diffuse scatter state, as shown in example 1702, the intermediate wireless device 106 can reflect signals from the transmitting node 904 in multiple directions with lower power into the corridor 1708 to provide coverage within the corridor 1708. In an example, the transmitting node 904 can configure the intermediate wireless device 106 to switch between states based on various considerations. In one specific example, the transmitting node 904 can configure the intermediate wireless device 106 to switch between states based on detecting occupancy (or not detecting occupancy) in the room 1704 (e.g., using a camera). In one specific example, the transmitting node 904 can configure the intermediate wireless device 106 to switch between states based on detecting occupancy (or not detecting occupancy) in the corridor 1708 (e.g., using a camera).

In accordance with various aspects described herein, one or more RISs can be placed on a larger background surface where the constituent elements of the RISs may permit finer control of their respective reflection coefficients, whereas the background surface can be configured to be in one of two (or more) states. Setting the background to be in reflective metal state (along with RISs it houses) can allow for communication via specular reflections with high reflected signal strength, depending on transceiver locations and set of available transmit and receive beams. Setting the background to be in diffuse scatterer state (along with RISs it houses) can allow for communication with limited beam alignment via diffuse scattering with lower reflected signal strength, which can be sufficient depending on transceiver locations and type of communications. Setting the background to be in diffuse scatterer state can allow for communication via anomalous reflections using the housed RIS with moderate reflected signal strength, while avoiding high side-lobes from the background reflections. Setting the background to be in metal state can allow for communication via anomalous reflections using the housed RIS with improved reflected signal strength (via coherent combining with signal reflected from background metal-state surface). Localization can be possible by conducting beam and pattern sweeps under different background state settings. Setting the background to be in either state can allow for multilayer communication via (anomalous) reflections from multiple housed RISs by avoiding keyhole channel effect.

In some examples, a network node that can control the intermediate wireless device can output a first set of configurations of a plurality of configurable elements of the intermediate wireless device for a beam-sweep operation. The network node can also obtain information relevant for setting the state of background elements of the intermediate wireless device. The network node can also output an indication of a configuration of the background elements of the intermediate wireless device. The network device can also obtain information relevant for setting the configuration of the plurality of configurable elements of the intermediate wireless device based on the beam sweep operation. The network device can also output an indication of a configuration of the plurality of configurable elements of the intermediate wireless device for a subsequent communication between the network device and the UE via the intermediate wireless device. In some examples, the indicated configuration of the background elements of the intermediate wireless device can be either a specular reflecting state configuration or a diffuse scattering state configuration. In some examples, the indicated configuration of the background elements of the intermediate wireless device can be achieved by the intermediate device by mechanical adjustment of a gap between constituent layers, whereas a configuration from the set of configurations of the plurality of configurable elements can be achieved by applying voltages on those configurable elements.

In some examples, the information relevant for setting the state of background elements can include a UE location, which can be determined based on received signal quality or power reports (for example via the opportunistic localization described elsewhere here) or a received indication of UE location. In this example, control component 442 can set the state of the background element to be reflective for UEs that are within a threshold distance or within a field of view or a known location desirable for receiving communications from the transmitting node via the intermediate wireless device that can be enhanced by specular reflection from the background element, or can set the state of the background element to be scattering for UEs that are not within the threshold distance or within a field of view or in a known location and for which specular reflection from the background element does not enhance communication received from the transmitting node via the intermediate wireless device.

In another example, the information relevant for setting the state of background elements can include an indication of a traffic demand, which can be determined by the transmitting node based on a number of UEs being served or an amount of data being transmitted for the UEs, etc. In this example, control component 442 can set the state of the background element to be reflective where traffic demand is low (e.g., and there may not be a large number of active UEs in the vicinity of the transmitting node or intermediate wireless device), or can set the state of the background element to be scattering where traffic demand is high (e.g., and there are a large number of active UEs in the vicinity of the transmitting node or intermediate wireless device).

In another example, the information relevant for setting the state of background elements can include an indication of a mobility status of a transmitting node or receiving node. In this example, control component 442 can set the state of the background element to be reflective for nodes that have a mobility status indicating that mobility is low (e.g., that the node is moving less than a threshold distance over a period of time or that the node is mobile less than a threshold period of time, etc.), such that the node in a substantially fixed, or slow varying, location over time can have transmitting signals reflected, or receive reflected signals, in a similar direction. In another example, control component 442 can set the state of the background element to be scattering for nodes that have a mobility status indicating that mobility is high (e.g., that the node is moving more than a threshold distance over a period of time or that the node is mobile more than a threshold period of time, etc.), such that the node that is mobile can have transmitting signals reflected, or receive reflected signals, in scattered or varying directions.

In another example, the information relevant for setting the state of background elements can include an indication of an intermediate device-to-UE (or receiving node) channel line-of-sight (LOS)/NLoS condition. In this example, control component 442 can set the state of the background element to be reflective for nodes that have a LOS condition, such that a receiving node in LOS of the intermediate wireless device can receive signals reflected from the reflective state surface having increased signal power over the scattering state surface. In another example, control component 442 can set the state of the background element to be scattering for nodes that have a NLoS condition, such that a receiving node in NLoS of the intermediate wireless device can receive signals reflected from the scattering state surface having additional reflect signal directions than the reflective state surface.

In some examples, the network node can indicate a second configuration of the background elements of the intermediate wireless device to be a specular reflection state configuration. The network node can also indicate a second configuration of a plurality of configurable elements of the intermediate wireless device. The network node can also determine a second set of configurations of a plurality of configurable elements of the network device for a beam-sweep operation. The network node can also perform a second beam sweep operation using the second set of configurations and estimating location of the UE based on the first and second beam sweep.

In some examples, an intermediate wireless device can obtain a first set of configurations of a plurality of configurable elements of the intermediate wireless device for a beam sweep operation. The intermediate wireless device can obtain an indication of a configuration of the background elements of the intermediate wireless device. The intermediate wireless device can perform, based on the first set of configurations of the plurality of configurable elements and the indicated background configuration, the beam sweep operation. The intermediate wireless device can obtain an indication of a configuration of the plurality of configurable elements for a subsequent communication between a network device and the UE based on the beam sweep operation. In some examples, the indicated configuration of the background elements of the intermediate wireless device can be either a specular reflecting state configuration or a diffuse scattering state configuration. In some examples, the indicated background configuration can be achieved by the intermediate device by mechanical adjustment of a gap between constituent layers, whereas a configuration from the set of configurations of the plurality of configurable elements can be achieved by applying voltages on those configurable elements. In some examples, the intermediate wireless device can obtain a second configuration of the background elements of the intermediate wireless device as a specular reflection state configuration. The intermediate wireless device can obtain a second configuration of a plurality of configurable elements of the intermediate wireless device. The intermediate wireless device can set a second configuration of the background elements of the intermediate wireless device to be a specular reflection state configuration. The intermediate wireless device can set a configuration of a plurality of configurable elements of the intermediate wireless to the obtained second configuration of the background elements of the intermediate wireless device.

FIG. 18 is a block diagram of a MIMO communication system 1800 including a base station 102 and a UE 104. The MIMO communication system 1800 may illustrate aspects of the wireless communication access network 100 described with reference to FIG. 1. The base station 102 may be an example of aspects of the base station 102 described with reference to FIG. 1. The base station 102 may be equipped with antennas 1834 and 1835, and the UE 104 may be equipped with antennas 1852 and 1853. In the MIMO communication system 1800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1820 may receive data from a data source. The transmit processor 1820 may process the data. The transmit processor 1820 may also generate control symbols or reference symbols. A transmit MIMO processor 1830 may perform spatial processing (e.g., precoding) on data symbols, control symbols, or reference symbols, if applicable, and may provide output symbol streams to the transmit modulator/demodulators 1832 and 1833. Each modulator/demodulator 1832 through 1833 may process a respective output symbol stream (e.g., for OFDM, etc.) to obtain an output sample stream. Each modulator/demodulator 1832 through 1833 may further process (e.g., convert to analog, amplify, filter, and upconvert) the output sample stream to obtain a DL signal. In one example, DL signals from modulator/demodulators 1832 and 1833 may be transmitted via the antennas 1834 and 1835, respectively.

The UE 104 may be an example of aspects of the UEs 104 described with reference to FIGS. 1 and 3. At the UE 104, the UE antennas 1852 and 1853 may receive the DL signals from the base station 102 (e.g., via an intermediate wireless device 106) and may provide the received signals to the modulator/demodulators 1854 and 1855, respectively. Each modulator/demodulator 1854 through 1855 may condition (e.g., filter, amplify, downconvert, and digitize) a respective received signal to obtain input samples. Each modulator/demodulator 1854 through 1855 may further process the input samples (e.g., for OFDM, etc.) to obtain received symbols. A MIMO detector 1856 may obtain received symbols from the modulator/demodulators 1854 and 1855, perform MIMO detection on the received symbols, if applicable, and provide detected symbols. A receive (Rx) processor 1858 may process (e.g., demodulate, deinterleave, and decode) the detected symbols, providing decoded data for the UE 104 to a data output, and provide decoded control information to a processor(s) 1880, or memory/memories 1882.

On the uplink (UL), at the UE 104, a transmit processor 1864 may receive and process data from a data source. The transmit processor 1864 may also generate reference symbols for a reference signal. The symbols from the transmit processor 1864 may be precoded by a transmit MIMO processor 1866 if applicable, further processed by the modulator/demodulators 1854 and 1855 (e.g., for single carrier-FDMA, etc.), and be transmitted to the base station 102 in accordance with the communication parameters received from the base station 102. At the base station 102, the UL signals from the UE 104 may be received by the antennas 1834 and 1835, processed by the modulator/demodulators 1832 and 1833, detected by a MIMO detector 1836 if applicable, and further processed by a receive processor 1838. The receive processor 1838 may provide decoded data to a data output and to the processor(s) 1840 or memory/memories 1842.

The processor(s) 1840 may in some cases execute stored instructions to instantiate a configuring component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 1800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1800.

The following aspects are illustrative only and aspects thereof may be combined with aspects of other embodiments or teaching described herein, without limitation.

Aspect 1 is a method for configuring one or more reflective elements and a background element of an intermediate wireless device to reflect wireless signals including receiving, from a network node, a first indication for configuring one or more reflective elements on the intermediate wireless device, configuring the one or more reflective elements based on the first indication, receiving, from the network node, a second indication for configuring a state of a background element of the intermediate wireless device, and configuring the state of the background element based on the second indication.

In Aspect 2, the method of Aspect 1 includes performing a beam sweep operation to allow the network node to obtain signal quality feedback reports from one or more UEs that can communicate with the network node via the intermediate wireless device, and receiving, from the network node, a third indication for updating the first indication or the second indication based on the beam sweep operation.

In Aspect 3, the method of Aspect 2 includes where the third indication relates to one or more of location of at least one of the one or more UEs, traffic demand, mobility status, or a line-of-sight or non-line-of-sight condition between the intermediate wireless device and at least one of the one or more UEs.

In Aspect 4, the method of any of Aspects 1 to 3 includes where the state corresponds to indicating one of a specular reflecting state or a diffuse scattering state of the background element.

In Aspect 5, the method of any of Aspects 1 to 4 includes where configuring the state of the background element includes setting a gap between two or more layers of the background element to achieve the state.

In Aspect 6, the method of Aspect 5 includes where the gap is configured based on an operating frequency of the wireless signals to be reflected.

In Aspect 7, the method of any of Aspects 5 or 6 includes where configuring the one or more reflective elements includes applying a voltage on the one or more reflective elements.

In Aspect 8, the method of any of Aspects 1 to 7 includes where the second indication relates to configuring the state of the background element as a diffuse scattering state, and performing a beam sweep operation based at least in part on the second indication or a third indication.

In Aspect 9, the method of Aspect 8 includes where the third indication includes at least one of an instruction to perform the beam sweep operation or information from the network node or a different network node related to a low side-lobe or low leakage interference parameter.

In Aspect 10, the method of any of Aspects 1 to 9 includes where the intermediate wireless device is a RIS.

In Aspect 11, the method of any of Aspects 1 to 10 includes where the background element includes at least a movable substrate layer, a scattering pattern layer, a dielectric layer, and a metal ground.

In Aspect 12, the method of Aspect 11 includes where the one or more reflective elements are attached to the movable substrate layer.

In Aspect 13, the method of any of Aspects 1 to 12 includes where the background element includes a dipole-array layer and a PEC ground plane layer.

In Aspect 14, the method of Aspect 13 includes where the one or more reflective elements are attached to the dipole-array layer.

Aspect 15 is a method for configuring an intermediate wireless device to reflect wireless signals that includes transmitting, to the intermediate wireless device, a first indication for configuring one or more reflective elements on the intermediate wireless device, and transmitting, to the intermediate wireless device, a second indication for configuring a state of a background element of the intermediate wireless device.

In Aspect 16, the method of Aspect 15 includes receiving, via the intermediate wireless device, signal quality reports from one or more UEs based on a beam sweep operation by at least one of the intermediate wireless device or a network node, and transmitting, to the intermediate wireless device and based on the received signal quality reports, an update to at least one of the first indication or the second indication.

In Aspect 17, the method of Aspect 16 includes where the update to at least one of the first indication or the second indication is further based on one or more of a UE location, traffic demand, mobility status, or a line-of-sight or non-line-of-sight condition between the intermediate wireless device and one or more UEs.

In Aspect 18, the method of any of Aspects 16 or 17 includes estimating, based on a beam direction or signal quality of one or more beams determined from the received signal quality reports, a location of the one or more UEs.

In Aspect 19, the method of any of Aspects 15 to 18 includes where the state corresponds to indicating one of a specular reflecting state or a diffuse scattering state of the background element.

In Aspect 20, the method of any of Aspects 15 to 19 includes where the second indication relates to configuring the state of the background element as a diffuse scattering state, and transmitting, to the intermediate wireless device, an instruction to perform a beam sweep.

In Aspect 21, the method of any of Aspects 15 to 20 includes where the intermediate wireless device is a RIS.

Aspect 22 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 21.

Aspect 23 is an apparatus for wireless communication including means for performing any of the methods of Aspects 1 to 21.

Aspect 24 is one or more computer-readable media including code executable by one or more processors for wireless communications, the code including code for performing any of the methods of Aspects 1 to 21.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
one or more reflective elements and a background element to reflect wireless signals;
one or more memories configured to, individually or in combination, store instructions; and
one or more processors communicatively coupled with the one or more memories, wherein the one or more processors are, individually or in combination, configured to execute the instructions to cause the apparatus to:
receive, from a network node, a first indication for configuring the one or more reflective elements;
configure the one or more reflective elements based on the first indication;
receive, from the network node, a second indication for configuring a state of the background element; and
configure the state of the background element based on the second indication.

2. The apparatus of claim 1, wherein the one or more processors are, individually or in combination, configured to execute the instructions to cause the apparatus to:
perform a beam sweep operation to allow the network node to obtain signal quality feedback reports from one or more user equipments (UEs) that can communicate with the network node via the apparatus; and
receive, from the network node, a third indication for updating the first indication or the second indication based on the beam sweep operation.

3. The apparatus of claim 2, wherein the third indication relates to one or more of location of at least one of the one or more UEs, traffic demand, mobility status, or a line-of-sight or non-line-of-sight condition between the apparatus and at least one of the one or more UEs.

4. The apparatus of claim 1, wherein the state corresponds to indicating one of a specular reflecting state or a diffuse scattering state of the background element.

5. The apparatus of claim 1, wherein the one or more processors are, individually or in combination, configured to execute the instructions to cause the apparatus to configure the state of the background element including setting a gap between two or more layers of the background element to achieve the state.

6. The apparatus of claim 5, wherein the gap is configured based on an operating frequency of the wireless signals to be reflected.

7. The apparatus of claim 5, wherein the one or more processors are, individually or in combination, configured to execute the instructions to cause the apparatus to configure the one or more reflective elements including applying a voltage on the one or more reflective elements.

8. The apparatus of claim 1, wherein the second indication relates to configuring the state of the background element as a diffuse scattering state, and wherein the one or more processors are, individually or in combination, configured to execute the instructions to cause the apparatus to perform a beam sweep operation based at least in part on the second indication or a third indication.

9. The apparatus of claim 8, wherein the third indication includes at least one of an instruction to perform the beam sweep operation or information from the network node or a different network node related to a low side-lobe or low leakage interference parameter.

10. The apparatus of claim 1, wherein the apparatus is a reconfigurable intelligent surface (RIS).

11. The apparatus of claim 1, wherein the background element includes at least a movable substrate layer, a scattering pattern layer, a dielectric layer, and a metal ground.

12. The apparatus of claim 11, wherein the one or more reflective elements are attached to the movable substrate layer.

13. The apparatus of claim 1, wherein the background element includes a dipole-array layer and a perfect electric conductor (PEC) ground plane layer.

14. The apparatus of claim 13, wherein the one or more reflective elements are attached to the dipole-array layer.

15. A method for configuring one or more reflective elements and a background element of an intermediate wireless device to reflect wireless signals, comprising:
receiving, from a network node, a first indication for configuring one or more reflective elements on the intermediate wireless device;
configuring the one or more reflective elements based on the first indication;
receiving, from the network node, a second indication for configuring a state of a background element of the intermediate wireless device; and
configuring the state of the background element based on the second indication.

16. The method of claim 15, further comprising:
performing a beam sweep operation to allow the network node to obtain signal quality feedback reports from one or more user equipments (UEs) that can communicate with the network node via intermediate wireless device; and
receiving, from the network node, a third indication for updating the first indication or the second indication based on the beam sweep operation.

17. The method of claim 15, wherein the state corresponds to indicating one of a specular reflecting state or a diffuse scattering state of the background element.

18. The method of claim 17, wherein configuring the state of the background element includes setting a gap between two or more layers of the background element to achieve the state.

19. One or more computer-readable media including code executable by one or more processors for configuring one or more reflective elements and a background element of an intermediate wireless device to reflect wireless signals, the code including code for:
receiving, from a network node, a first indication for configuring one or more reflective elements on the intermediate wireless device;
configuring the one or more reflective elements based on the first indication;
receiving, from the network node, a second indication for configuring a state of a background element of the intermediate wireless device; and
configuring the state of the background element based on the second indication.

20. The one or more computer-readable media of claim 19, the code including code for:
performing a beam sweep operation to allow the network node to obtain signal quality feedback reports from one or more user equipments (UEs) that can communicate with the network node via intermediate wireless device; and
receiving, from the network node, a third indication for updating the first indication or the second indication based on the beam sweep operation.
